(19) United States
(12) Patent Application Publication
(10) Pub. No.: US 2026/0253303 A1
(43) Pub. Date: Aug. 27, 2026

(54) METHOD AND APPARATUS FOR GENERATING DYNAMIC BACKGROUND, DEVICE, MEDIUM AND PROGRAM PRODUCT

(71) Applicant: Beijing Zitiao Network Technology Co., Ltd., Beijing (CN)

(72) Inventor: Ziyan LI, Beijing (CN)

(21) Appl. No.: 19/548,115

(22) Filed: Feb. 24, 2026

(30) Foreign Application Priority Data
Feb. 25, 2025 (WO) PCT/CN2025/079105

(51) Int. Cl. G06T 13/80; G06T 3/60; G06T 5/70; G06T 11/10

(52) U.S. Cl. CPC G06T 13/80; G06T 3/60; G06T 5/70; G06T 11/10; G06T 2200/24

(57) ABSTRACT

Embodiments of the present disclosure relate to a method and apparatus for generating a dynamic background, a device, a medium and a program product. The method includes determining, from a user interface, a plurality of colors available for the dynamic background. The method also includes generating a plurality of color layers based on the plurality of colors, and wherein colors in the plurality of color layers are different. The method also includes determining a dynamic graphic and an animation effect corresponding to the plurality of color layers. The method further includes generating the dynamic background based on the plurality of color layers, the dynamic graphic and the animation effect.

### CROSS-REFERENCE TO RELATED APPLICATIONS

This application claims priority to International Patent Application No. PCT/CN2025/079105 filed on February 25, 2025, the disclosure of which is incorporated herein by reference in its entity.

### FIELD

Embodiments of the present disclosure generally relate to the field of computer graphics technology, and more specifically, to a method and apparatus for generating a dynamic background, a device, a medium and a program product.

### BACKGROUND

At present, development of dynamic background technology has gradually become a vital part in user interface design. In the fields of e-commerce, social contact, entertainment etc., applications of dynamic background add more visual appeals and interactivity to the user interface. To develop the user interface design, it is required to fully consider the balance between visual effects and performance optimization. Therefore, it has become the focus of many developer research to enhance visual experience of the users through innovative dynamic background technology. The developers are dedicated to constantly boost the interactive experience between the user and the interface with the efficient rendering techniques.

With continuous evolution of user page design, how to enhance visual appeal and individualized experience through dynamic effects has become particularly important, wherein generation of real-time dynamic effects has become a key development direction. For users, smoothness of interface effects and real-time interaction with the user interface are vital because they can enhance the immersive experience of the interface interaction and significantly improve the overall experience of the user.

### SUMMARY

Embodiments of the present disclosure provide a method and apparatus for generating a dynamic background, a device, a medium and a program product.

In accordance with a first aspect of the present disclosure, there is provided a method for generating a dynamic background. The method includes determining, from a user interface, a plurality of colors available for the dynamic background. The method also includes generating a plurality of color layers based on the plurality of colors, and wherein colors in a plurality of color layers are different. The method also includes determining a dynamic graphic and an animation effect corresponding to the plurality of color layers. The method further includes generating the dynamic background based on the plurality of color layers, the dynamic graphic and the animation effect.

In accordance with a second aspect of the present disclosure, there is provided an apparatus for generating a dynamic background. The apparatus includes a color determination module, configured to determine, from a user interface, a plurality of colors available for the dynamic background; a color layer generating module, configured to generate a plurality of color layers based on the plurality of colors, and wherein colors in the plurality of color layers are different; a dynamic graphic and animation effect determination module, configured to determine a dynamic graphic and an animation effect corresponding to the plurality of color layers; and a dynamic background generating module, configured to generate the dynamic background based on the plurality of color layers, the dynamic graphic and the animation effect.

In accordance with a third aspect of the present disclosure, there is provided an electronic device, the electronic device includes at least one processor; and a storage apparatus, configured to store at least one program, the at least one program, when executed by the at least one processor, causes the at least one processor to implement the method according to the first aspect of the present disclosure.

In accordance with a fourth aspect of the present disclosure, there is provided a computer-readable storage medium storing a computer program thereon, the computer program, when executed by a processor, implements the method according to the first aspect of the present disclosure.

In accordance with a fifth aspect of the present disclosure, there is provided a computer program product. The computer program product includes a computer program, the computer program, when executed by a processor, implements the method according to the first aspect of the present disclosure.

It should be appreciated that the contents described in this Summary are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for generating a dynamic background according to some embodiments of the present disclosure;

FIG. 3 illustrates a schematic diagram of an example of extracting colors in a terminal and generating a dynamic background according to some embodiments of the present disclosure;

FIG. 4 illustrates a schematic diagram of an example for generating a dynamic background according to some embodiments of the present disclosure;

FIG. 5 illustrates a schematic diagram of an example of implementation effect according to some embodiments of the present disclosure;

FIG. 6 illustrates a schematic block diagram of an apparatus for generating a dynamic background according to some embodiments of the present disclosure;

FIG. 7 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

An implementation of a traditional dynamic background in general depends on existing animation materials or simple transformations of static pictures. In case that the existing animation materials are used to implement the dynamic background, designers need to design and store the animation materials in advance. However, with a small amount of animation materials being designed, diversity of dynamic effects may be restricted; if a large amount of animation materials is designed, storage costs may soar. In case that the dynamic background is implemented through simple transformations of static pictures, background effects could not be adjusted in accordance with changes in contents of the user interface, the flexibility here is poor. Meanwhile, the above two approaches often fail to provide an immersive and individualized experience to the user as they are not linked with the contents of the user interface. In addition, the traditional dynamic background would create a great performance pressure when being applied on a mobile terminal or a device with limited resources. This may further impact the user experience.

For this, embodiments of the present disclosure provide a method for generating a dynamic background. In this method, a computing device obtains a plurality of colors using the user interface. The computing device further generates a plurality of color layers from a plurality of colors, wherein colors between each color layer are gradient. Next, the computing device may determine a corresponding dynamic graphic and an animation effect based on a plurality of color layers generated and finally generate the dynamic background by combining a plurality of color layers, the corresponding dynamic graphic and the corresponding animation effect. According to this method, colors are extracted from the user interface to generate and update the dynamic background. Therefore, design and storage costs are reduced, and flexibility and interactivity of dynamic effects are boosted. Moreover, resource consumption is lowered, immersive experience is enhanced and user experience is improved.

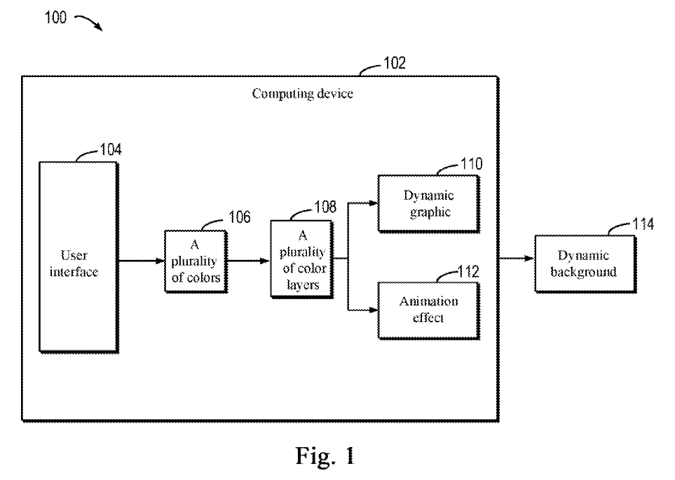

Embodiments of the present disclosure are to be described in details below with reference to the drawings, wherein FIG. 1 illustrates an example environment in which the device and/or method of the embodiments of the present disclosure may be implemented. In the environment 100, the computing device 102 may determine a plurality of colors available for the dynamic background and a dynamic graphic and an animation effect corresponding to a plurality of colors.

Examples of the computing device 102 include, but not limited to, personal computer, server computer, hand-held or laptop device, mobile device (e.g., mobile phone, Personal Digital Assistant (PDA), and media player etc.), multi-processor system, consumer electronic product, minicomputer, large-scale computer, and a distributed computing environment including any of the above systems or devices.

As shown in FIG. 1, in a scenario where it is required to generate the dynamic background, the computing device 102 extracts colors from the user interface 104. In one example, the extracted colors may be one color in the user interface, such as a primary color or a color as auxiliary tone in the user interface. Saturability and/or brightness of the colors extracted from the user interface may be adjusted to generate a plurality of differentiated colors, i.e., a plurality of colors 106. The plurality of colors is placed in a color array, and the colors in the array are used to generate the dynamic background. For example, the computing device 102 passes the color into a shader and adjusts saturability and/or brightness of the color in the shader to generate a plurality of colors. In some embodiments, the computing device 102 may sample a plurality of colors directly from the user interface 104. The above examples are provided merely for describing the present disclosure, rather than restricting it.

Furthermore, the computing device 102 may utilize a plurality of colors to generate a plurality of color layers for use in the dynamic background. For example, two colors are selected from a plurality of colors and the two selected colors are then used to generate a gradient layer. In some embodiments, the two colors are processed by a mix function to generate a color layer, thereby fulfilling a color gradient effect. The mix function receives an input of two colors, one of which is used as a starting color of the gradient and the other of which serves as an ending color of the gradient. The two colors, as two ends of the gradient, gradually transition from one to the other via an algorithm.

For example, in the shader, two colors from the color array are input into the mix function to realize smooth transition effect of the color. In case that the starting color of the gradient is at an edge of the screen and the ending color of the gradient is at the center of the screen, each layer of gradient color is controlled by a distance between a pixel and the center during the generation of the gradient color layer. For example, the generation of the gradient color is determined by a distance between the pixel and the center and a square of this distance.

In some embodiments, during the transition of the color gradient, the transitional color is controlled by an interpolation factor, wherein a value of the interpolation factor is between 0 and 1. In one example, the starting color of the gradient is at an edge of the screen and the ending color of the gradient is at the center of the screen. The interpolation factor may be determined by a distance between the pixel and the center and a square of this distance. In another example, the interpolation factor may be generated automatically or designed manually in view of the specific requirements. When the interpolation factor is 0, the generated color is exactly the starting color; when the interpolation factor is 1, the generated color is exactly the ending color; when the interpolation color is between 0 and 1, the generated color is a mixture of the starting color and the ending color at a ratio. For example, an interpolation factor of 0.5 indicates an even mixture of the starting color and the ending color, i.e., each color takes up 50%. As the interpolation factor smoothly changes to 1 from 0, the starting color gradually decreases and the ending color gradually increases. The overall transition process is linear, so the color variation is smooth and even visually.

Accordingly, the above process may be repeated on every two colors of a plurality of colors respectively, so as to generate a plurality of color layers 108 and achieve a smooth transition of the colors of the entire picture. For example, colors having a subscript of 0 and colors having a subscript of 1 in the color array may define a first layer of the gradient; and colors having a subscript of 1 and colors having a subscript of 2 in the color array define a second layer. The process is repeated to generate a plurality of color layers 108. With such layered design, the overall gradient exhibits a layering sense and the color change is even and smooth visually.

Then, the computing device 102 also generates a dynamic graphic 110 and an animation effect 112 corresponding to a plurality of color layers. For example, the animation effect is generated by combining time variable, sine wave, angle calculation and polar coordinate transformation, wherein the time variable, as a core driving factor of the dynamic effect, constantly updates the time value in the rendering process and combines with other mathematical functions to produce a periodic transformation, such that the texture has a smooth animation effect. For instance, as time progresses, color gradient, texture rotation or ripple expansion is all under control.

In some embodiments, through the periodic change of the sine wave, a cyclic dynamic process in the texture, such as ripple expansion or halo flicker, can be controlled, and the periodic change of ripple and shadow effects may also be simulated. The angle calculation and the polar coordinate transformation, combined with the sine wave, can achieve the animation effect of rotating ripples or spirals. Moreover, a preset matrix for rotating animation texture may also be used to multiply the original coordinates by a corresponding matrix, to obtain the corresponding position coordinates after rotation. The effects of the original pixels are then copied to the corresponding rotated pixels, to implement rotation of the animation texture.

Therefore, when the above methods are combined to generate animation effects, rich animation effects may be obtained. In some embodiments, the time variable is combined with the sine wave to generate periodic wave texture, such as ripple expansion or ripple effects; and an animation texture based on a circular or spiral path, e.g., halo rotation or swirling motion, may be generated through the angle calculation and the polar coordinate transformation; by means of the rotation transform and the time control, dynamic rotating effects of the texture may be achieved, so as to add sense of hierarchy and dynamic effects to the animation. Meanwhile, visual appeal and interactivity of the user interface may also be enhanced by dynamically adjusting the time variable, the rotation angle and the fluctuation frequency.

In some embodiments, the corresponding dynamic graphic 110 may also be generated according to a plurality of color layers. Forms of the dynamic graphic may be determined from the input of adjustable parameters in the preset function. For example, the dynamic graphic may be determined from parameters such as input angle, radius, time, etc.

Meanwhile, if an edge of the graphics is too stiff or jagged in the dynamic effect, the visual experience is poor. By smoothing the edge, the dynamic graphic may become more natural and smoother, so as to fuse better with the background color layer. In some embodiments, transparency or color of the graphic edge area is interpolated by a smooth transition function (Smoothstep), to gradually blur the boundary. Subsequent to the smoothing process, edges of the dynamic graphics are free of abrupt boundary and the transition to the background color is more natural while the overall visual smoothness and immersive sense are boosted.

In the end, the final dynamic background 114 is generated based on the plurality of color layers, the dynamic graphic and the animation effect. The color layers provide multiple gradient colors, the dynamic graphic enhance the layers and the dynamic effects, and the animation effect closely combine the color layers with the dynamic graphic to present a smooth and vivid dynamic background in the end. A plurality of adjustable parameters in the dynamic background may allow the users to adjust the dynamic background by their preferences. The user experience is therefore further improved.

In addition, with techniques of the shader in Graphics Processing Unit (GPU), massive graphic computation tasks may be transferred from a Central Processing Unit (CPU) to the GPU, to give full play to the GPU parallel processing capability. The load of the CPU is significantly reduced while the overall system performance is enhanced.

According to this method, colors are extracted from the user interface to generate and update the dynamic background. Therefore, design and storage costs are reduced, and flexibility and interactivity of dynamic effects are boosted. Moreover, resource consumption is lowered, immersive experience is enhanced and user experience is improved.

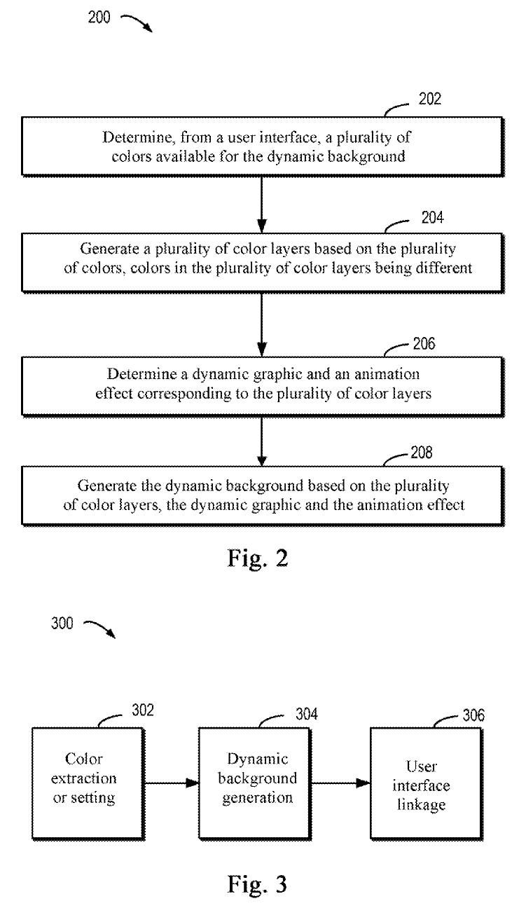

The schematic diagram of the example environment in which the device and/or method according to some embodiments of the present disclosure may be implemented has been described above with reference to FIG. 1. Next, a schematic diagram of an example method for generating a dynamic background according to some embodiments of the present disclosure is to be depicted below with reference to FIG. 2. The method in FIG. 2 may be executed by the computing device 102 in FIG. 1 and/or any suitable computing devices.

As shown in FIG. 2, in the example method 200, at block 202, the computing device 102 determines, from the user interface, a plurality of colors available for the dynamic background, wherein the determined plurality of colors is decided based on changes of the contents in the user interface. The colors in the user interface are extracted after the changes of the contents in the user interface.

In some embodiments, the plurality of colors is obtained by adjusting one color extracted from the user interface. For example, a primary color of the user interface is extracted and at least one of saturability or brightness of the primary color are adjusted to generate a plurality of colors. In one example, the primary color of the interface is determined by the color histogram, which calculates the frequency of occurrence of each color in the user interface and determines a color corresponding to the color interval with the highest frequency of occurrence as the primary color. In another example, the primary color may be determined by a clustering method. The above examples are provided merely for describing the present disclosure, rather than restricting it.

In some embodiments, a plurality of colors is directly obtained from the user interface. At this point, the computing device clusters pixel colors in the user interface using a clustering algorithm (K-Means) to determine a plurality of colors. For example, the computing device first uses the color value of each pixel of the graphic as a data point, divides it into several color clusters via the K-Means algorithm and selects a color at the center of each cluster as the color to be used. In case of interface subject switching, the algorithm extracts in real time a new primary color or a plurality of colors, which is passed into the shader to generate a corresponding background effect. It is ensured by this algorithm that the dynamic background can be adjusted in real time in accordance with the changes of the user interface, so as to enhance visual consistency and user experience.

At block 204, a plurality of color layers is generated based on a plurality of colors and colors in the plurality of color layers are different. Each color layer is a color smooth transition layer generated based on a group of input colors and the color of each layer is visually independent of one another, but they form an overall dynamic background by overlay and gradient. In some embodiments, two colors are selected from the color array as the starting color and the ending color of the current color layer, e.g., color with a subscript of 0 and color with a subscript of 1 in the color array. Then, a smooth transition is implemented between the starting color and the ending color with the interpolation function (e.g., mix function) to form a color layer. The transparency, position or animation speed of different color layers are adjusted to present richer visual levels. The color layer is generated depending on a distance between the pixel and the center or a square of this distance, to realize a radial gradient effect from inside to outside.

In this method, a plurality of color layers is generated based on a plurality of colors. By selecting different colors, designing gradient effects and overlay modes, the color layers are independent of one another in the dynamic background but also coordinate with each other, to form rich and vivid visual effects. In combination with a dynamic change mechanism, a plurality of color layers makes the dynamic background flexible and expressive. In addition, each color layer may be associated with a corresponding time.

At block 206, a dynamic graphic and an animation effect corresponding to the plurality of color layers are determined. Each color layer defines the color of the dynamic background, and these colors provide visual and structural supports to the generation of the dynamic graphic.

In some embodiments, in order to determine the dynamic graphic and the animation effect, the computing device may generate, in accordance with a plurality of color layers, the animation effect corresponding thereto. For example, the computing device processes the plurality of color layers through at least one of sine wave, angle calculation and polar coordinate transformation, so as to generate an animation texture corresponding to the plurality of color layers. Besides, the processing is also closely associated with the time variable. In such case, different color layers may be selected according to different time, to generate dynamic animation effects.

Additionally, when the animation effect corresponding to the plurality of color layers is being generated, the generated texture may also be rotated. In such case, the computing device 102 may generate a matrix for rotating the animation texture. In one example, a corresponding rotation matrix is generated by inputting a rotation angle into a preset function rotated2d. In another example, a plurality of rotation matrices for different angles may be preset. When the animation texture is to be rotated, a rotation matrix may be selected from a plurality of rotation matrices according to the rotation angle. The computing device then further rotates the animation texture based on the matrix. For example, a texture value corresponding to a position point is rotated to a rotated position point by multiplying the rotation matrix by coordinates of the position point in the texture.

Moreover, the computing device 102 also may generate the dynamic graphic corresponding to a plurality of color layers in accordance with some predefined parameters. For example, the predefined parameters may include angle, radius, time and the number of shape components. For instance, when a dynamic background in the shape of a petal is to be generated, the number of shape components may determine how many petals are included in the dynamic graphic. If the number of shape components is 6, there may be 6 petals. Further, the input parameter radius defines the size of the shape, and the angle may be used to define the structure of the shape. Besides, different background shapes may be set for various time points. Different color layers may be assigned to shapes at various time points by a corresponding relation with the time.

In addition, after the dynamic graphic is generated, it is also possible to smooth the dynamic graphic. For example, the computing device 102 may smooth an edge of the dynamic graphic via a preset function, such as Smoothstep function.

In the end, at block 208, the dynamic background is generated based on a plurality of color layers, the dynamic graphic and the animation effect. The final dynamic background is realized by combining the color layers, the dynamic graphic and the animation effect, wherein the color layer, as the base of the dynamic background, defines the overall color structure and the layered sense of the background; the dynamic graphic is generated from a geometrical shape, to add the shape of the graphic to be displayed on the background; and the animation effect controls the animation texture of the color layers and the dynamic graphic, to enhance interactivity and immersion of the background.

In some embodiments, after the dynamic background is generated, the generated dynamic background may also be further adjusted. For example, the computing device 102 may provide a set of adjustable parameters for the dynamic background, such as parameters for adjusting brightness of the dynamic background, parameters for adjusting blurriness of the shape edge and parameters for adjusting the size of the shape in the dynamic background. The above examples are provided merely for describing the present disclosure, rather than restricting it. Those skilled in the art may set any suitable parameters in accordance with the requirements. Then, the dynamic background may be adjusted by adjusting an adjustable parameter in the set of adjustable parameters.

To facilitate the description, the plurality of colors stated above may also be referred to as a first plurality of colors. In some embodiments, after the dynamic background is generated, if a change occurs to the user interface of the user, the computing device 102 may further determine a second plurality of colors for the changed user interface. Afterwards, the computing device updates the dynamic background in accordance with a second plurality of colors.

According to this method, colors are extracted from the user interface to generate and update the dynamic background. Therefore, design and storage costs are reduced, and flexibility and interactivity of dynamic effects are boosted. Moreover, resource consumption is lowered, immersive experience is enhanced and user experience is improved.

The schematic diagram of the example method for generating a dynamic background in accordance with some embodiments of the present disclosure has been described above with reference to FIG. 2. Next, a schematic diagram of an example of extracting colors in a terminal and generating a dynamic background in accordance with some embodiments of the present disclosure is to be depicted in conjunction with FIG. 3. The example shown in FIG. 3 may be executed by the computing device 102 in FIG. 2 or any suitable devices.

In the example 300 of FIG. 3, at block 302, the computing device 102 extracts or sets the color. In this process, the computing device 102 may extract the primary color from the interface elements (such as pictures etc.) and then store the extracted color data in the form of an RGB value as the input to the generation of the dynamic background.

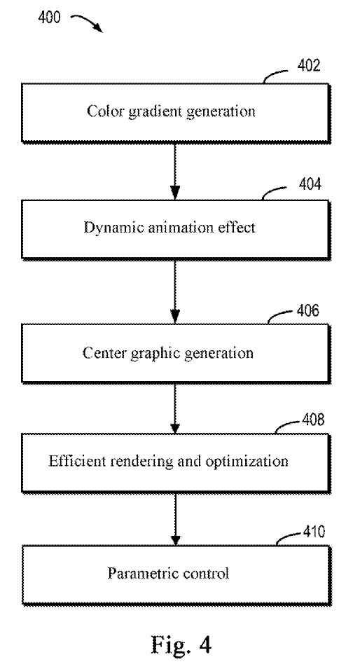

At block 304, the computing device 102 generates the dynamic background. In this process, the computing device 102 passes the extracted color data to the GPU shader. Then, the dynamic effect is generated in the shader using the color data. For example, dynamic effects such as ripple and flowing are implemented through a sine wave function. This process is to be described in details below with reference to FIG. 4.

At block 306, the computing device 102 further links with the user interface. During the linkage, the computing device 102 may detect changes of the contents in the user interface (such as subject switching and content update). Then, the color data are re-extracted in real time and the input to the shader is updated in accordance with the changes of the contents in the user interface. Therefore, dynamic background effects transition smoothly along with the changes of the user interface, to avoid causing an obtrusive visual feel.

The schematic diagram of the example of extracting colors in a terminal and generating a dynamic background in accordance with some embodiments of the present disclosure has been described above with reference to FIG. 3. Next, a schematic diagram of an example for generating a dynamic background in accordance with some embodiments of the present disclosure is to be depicted in conjunction with FIG. 4. The example 400 in FIG. 4 mainly describes the generation of the dynamic background in FIG. 3. The example 400 of FIG. 4 may be implemented by the computing device 102 in FIG. 1 or any suitable computing devices.

At block 402, the computing device 102 performs an operation of generating color gradient. In this operation, the computing device 102 uses a color array including from uColor[0] to uColor[3] as the input. The color array consists of four colors, which for example are obtained from adjusting the primary color extracted from the user interface. Next, the computing device 102 may fulfill smooth transition of the color via the mix function. The gradient color is generated based on a distance (r) between the pixel and the center and a square of this distance (r²), to achieve a layered gradient effect.

At block 404, the computing device 102 may form the dynamic animation effect. The dynamic effect is controlled by the time variable uTime and combined with the sine wave, the angle calculation (atan) and the polar coordinate transformation to produce a complicated animation texture. Moreover, the computing device 102 also may use rotate2d function to cause rotational changes of the texture and increase dynamics.

At block 406, the computing device 102 generates a center graphic. For example, in this process, the computing device 102 generates a dynamic graphic that spreads from the center to the outside using butterFlyOriginal function. The shape of the dynamic graphic is controlled by the angle a, the radius r and the time t. Furthermore, the computing device 102 also may process the edges of the graphic. For instance, the smooth transition is implemented by the Smoothstep function to avoid abrupt boundaries.

At block 408, the computing device 102 may efficiently perform rendering and optimization. In this process, the computing device 102 may generate a dynamic texture in real time through the parallel computation capability of the GPU, to avoid storage and loading of the pre-rendered materials. Besides, in the above process, the computation complexity is reduced using simple mathematical functions (such as cos, sin and mix) while the smoothness of the dynamic effect is ensured.

At block 410, the computing device 102 also may carry out the parametric control. In this process, the computing device 102 provides a plurality of adjustable parameters (e.g., uLightness, uEffect and uScale etc.) to flexibly adjust the dynamic background, wherein uLightness is used to adjust the brightness of the dynamic background, uEffect is used to adjust the blurriness of the shape edges of the dynamic background, and uScale is used to adjust the size of the graphic in the dynamic background. Furthermore, the computing device also may adapt resolution and direction of different devices through the parameters uResolution and uDirection.

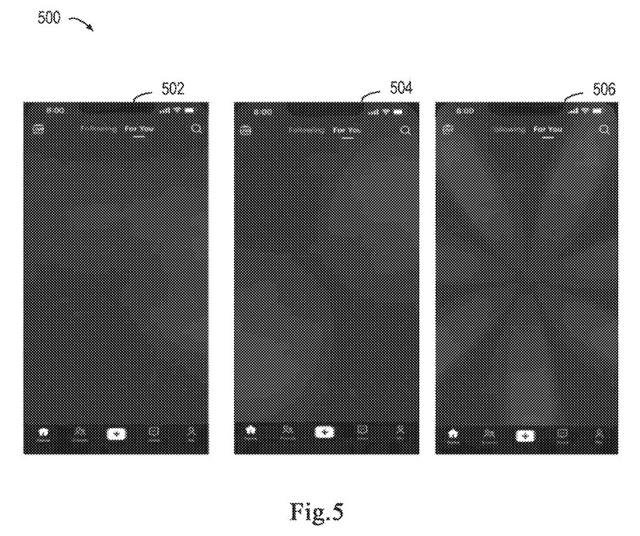

Next, a schematic diagram of the dynamic background in accordance with some embodiments of the present disclosure is to be depicted in conjunction with FIG. 5. The example 500 of FIG. 5 demonstrates dynamic backgrounds generated based on a plurality of color layers in combination with different dynamic graphics and various animation effects. The dynamic background is presented in graphic 502, graphic 504 and graphic 506 at three different time points respectively. The dynamic background has different shapes and colors at various time points. The graphic 502 illustrates one petal; the graphic 504 shows two petals; and the graphic 506 presents six petals. The petal in each graphic is in different color.

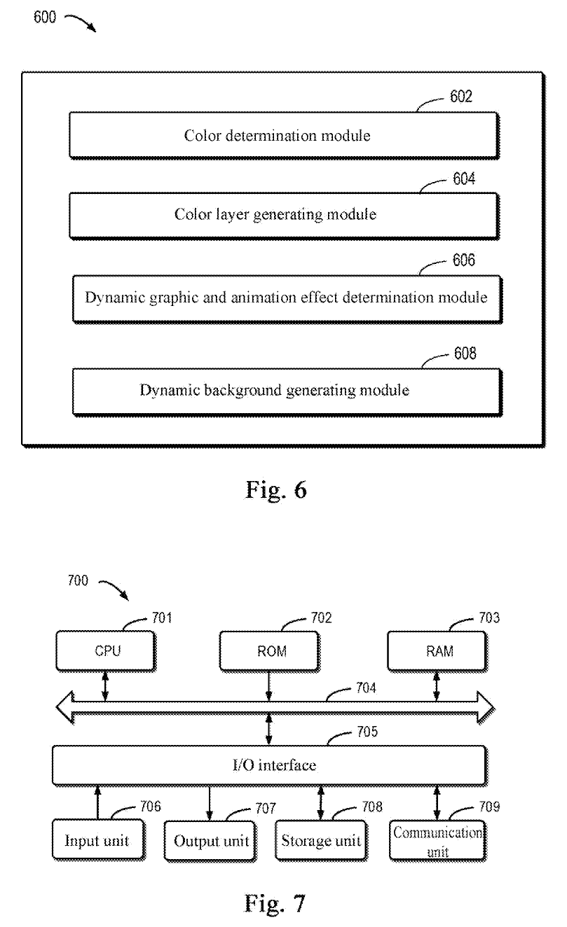

FIG. 6 illustrates a schematic diagram of an apparatus for generating a dynamic background in accordance with some embodiments of the present disclosure. According to FIG. 6, the apparatus 600 includes a color determination module 602, configured to determine, from a user interface, a plurality of colors available for the dynamic background; a color layer generating module 604, configured to generate a plurality of color layers based on the plurality of colors, and wherein colors in the plurality of color layers are different; a dynamic graphic and animation effect determination module 606, configured to determine a dynamic graphic and an animation effect corresponding to the plurality of color layers; and a dynamic background generating module 608, configured to generate the dynamic background based on the plurality of color layers, the dynamic graphic and the animation effect.

In some embodiments, the color determination module 602 includes: a color extracting module, configured to extract a color from the user interface; and a color generating module, configured to generate the plurality of colors by adjusting the color.

In some embodiments, the color layer generating module 604 includes a color adjusting module, configured to generate the plurality of colors by adjusting at least one of saturability or brightness of the colors.

In some embodiments, the color extracted from the user interface is a primary color of the user interface.

In some embodiments, the color layer generating module 604 includes: a color selecting module, configured to select two colors from the plurality of colors; a pixel distance determination module, configured to determine a distance from a pixel in a display corresponding to the user interface to a center of the display; and a gradient color layer generating module, configured to generate a color layer based on the two colors and the distance, wherein colors in the color layer are gradient.

In some embodiments, the dynamic graphic and animation effect determination module 606 includes: an animation effect determination module, configured to generate, based on the plurality of color layers, the animation effect corresponding to the plurality of color layers; and a dynamic graphic determination module, configured to generate the dynamic graphic corresponding to the plurality of color layers based on predetermined parameters.

In some embodiments, the animation effect determination module includes an animation texture generating module, configured to generate an animation texture corresponding to the plurality of color layers by processing the plurality of color layers with at least one of sine wave, angle calculation or polar coordinate transformation.

In some embodiments, the animation effect determination module also includes: a rotation matrix determination module, configured to determine a matrix for rotating the animation texture; and an animation texture rotating module, configured to rotate the animation texture based on the rotation matrix.

In some embodiments, the dynamic graphic determination module includes: a dynamic graphic generating module, configured to generate the dynamic graphic for the dynamic background via a preset function; and an edge processing module, configured to smooth an edge of the dynamic graphic.

In some embodiments, the apparatus 600 also includes: a dynamic background adjusting module, configured to provide a set of adjustable parameters for the dynamic background; and the dynamic background adjusting module, configured to adjust the dynamic background by adjusting an adjustable parameter in the set of adjustable parameters.

In some embodiments, the apparatus 600 also includes: a module for determining a second plurality of colors, configured to, in response to a change in contents of the user interface, determine a second plurality of colors for the changed user interface; and a dynamic background update module, configured to update the dynamic background based on the second plurality of colors.

FIG. 7 illustrates a schematic block diagram of an example device 700 for implementing embodiments of the present disclosure. The computing device 102 in FIG. 1 may be implemented by the device 700. As shown in FIG. 7, the device 700 includes a central process unit (CPU) 701, which can execute various suitable actions and processing based on the computer program instructions stored in the read-only memory (ROM) 702 or computer program instructions loaded in the random-access memory (RAM) 703 from the storage unit 708. The RAM 703 can also store all kinds of programs and data required by the operation of the device 700. CPU 701, ROM 702 and RAM 703 are connected to each other via a bus 704. The input/output (I/O) interface 705 is also connected to the bus 704.

A plurality of components in the device 700 is connected to the I/O interface 705, including: an input unit 706, such as keyboard, mouse and the like; an output unit 708, e.g., various kinds of display and loudspeakers etc.; a storage unit 708, such as disk and optical disk etc.; and a communication unit 709, such as network card, modem, wireless transceiver and the like. The communication unit 709 allows the device 700 to exchange information/data with other devices via the computer network, such as Internet, and/or various telecommunication networks.

The above described procedure and processing, such as method 200 and examples 300-400, can be executed by the processing unit 701. For example, in some embodiments, method 200 and examples 300-400 can be implemented as a computer software program tangibly included in the machine-readable medium, e.g., storage unit 708. In some embodiments, the computer program can be partially or fully loaded and/or mounted to the apparatus 700 via ROM 702 and/or communication unit 709. When the computer program is loaded to RAM 703 and executed by the CPU 701, one or more actions of the above described example method 200 and examples 300-400.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages include object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions includes an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

We claim:

1. A method for generating a dynamic background, comprising:
determining, from a user interface, a plurality of colors available for the dynamic background;
generating a plurality of color layers based on the plurality of colors, colors in the plurality of color layers being different;
determining a dynamic graphic and an animation effect corresponding to the plurality of color layers; and
generating the dynamic background based on the plurality of color layers, the dynamic graphic and the animation effect.

2. The method of claim 1, wherein determining, from the user interface, the plurality of colors available for the dynamic background comprises:
extracting a color from the user interface; and
generating the plurality of colors by adjusting the color.

3. The method of claim 2, wherein generating the plurality of colors by adjusting the color comprises:
generating the plurality of colors by adjusting at least one of saturability or brightness of the colors.

4. The method of claim 2, wherein the color is a primary color of the user interface.

5. The method of claim 1, wherein generating the plurality of color layers based on the plurality of colors comprises:
selecting two colors from the plurality of colors;
determining a distance from a pixel in a display corresponding to the user interface to a center of the display; and
generating a color layer based on the two colors and the distance, wherein colors in the color layer are gradient.

6. The method of claim 1, wherein determining the dynamic graphic and the animation effect corresponding to the plurality of color layers comprises:
generating, based on the plurality of color layers, the animation effect corresponding to the plurality of color layers; and
generating the dynamic graphic corresponding to the plurality of color layers based on a predetermined parameter.

7. The method of claim 6, wherein generating the animation effect corresponding to the plurality of color layers comprises:
generating an animation texture corresponding to the plurality of color layers by processing the plurality of color layers with at least one of sine wave, angle calculation or polar coordinate transformation.

8. The method of claim 7, wherein generating the animation effect corresponding to the plurality of color layers comprises:
determining a matrix for rotating the animation texture; and
rotating the animation texture based on the matrix.

9. The method of claim 6, wherein generating the dynamic graphic corresponding to the plurality of color layers based on the predetermined parameter comprises:
generating the dynamic graphic for the dynamic background via a preset function; and
smoothing an edge of the dynamic graphic.

10. The method of claim 4, further comprising:
providing a set of adjustable parameters for the dynamic background; and
adjusting the dynamic background by adjusting an adjustable parameter in the set of adjustable parameters.

11. The method of claim 1, wherein the plurality of colors are a first plurality of colors, and the method further comprises:
in response to a change in content of the user interface, determining a second plurality of colors for the changed user interface; and
updating the dynamic background based on the second plurality of colors.

12. An electronic device, comprising:
at least one processor; and
a storage, configured to store at least one program, wherein the at least one program, when executed by the at least one processor, causes the at least processor to:
determine, from a user interface, a plurality of colors available for the dynamic background;
generate a plurality of color layers based on the plurality of colors, colors in the plurality of color layers being different;
determine a dynamic graphic and an animation effect corresponding to the plurality of color layers; and
generate the dynamic background based on the plurality of color layers, the dynamic graphic and the animation effect.

13. The electronic device according to claim 12, wherein the at least one program causing the at least one processor to determine, from the user interface, the plurality of colors available for the dynamic background further causes the at least one processor to:
extract a color from the user interface; and
generate the plurality of colors by adjusting the color.

14. The electronic device according to claim 13, wherein the at least one program causing the at least one processor to generate the plurality of colors by adjusting the color further causes the at least one processor to:
generate the plurality of colors by adjusting at least one of saturability or brightness of the colors.

15. The electronic device according to claim 13, wherein the color is a primary color of the user interface.

16. The electronic device according to claim 12, wherein the at least one program causing the at least one processor to generate the plurality of color layers based on the plurality of colors further causes the at least one processor to:
select two colors from the plurality of colors;
determine a distance from a pixel in a display corresponding to the user interface to a center of the display; and
generate a color layer based on the two colors and the distance, wherein colors in the color layer are gradient.

17. The electronic device according to claim 12, wherein the at least one program causing the at least one processor to determine the dynamic graphic and the animation effect corresponding to the plurality of color layers further causes the at least one processor to:
generate, based on the plurality of color layers, the animation effect corresponding to the plurality of color layers; and
generate the dynamic graphic corresponding to the plurality of color layers based on a predetermined parameter.

18. The electronic device according to claim 17, wherein the at least one program causing the at least one processor to generate the animation effect corresponding to the plurality of color layers further causes the at least one processor to:
generate an animation texture corresponding to the plurality of color layers by processing the plurality of color layers with at least one of sine wave, angle calculation or polar coordinate transformation.

19. The electronic device according to claim 18, wherein the at least one program causing the at least one processor to generate the animation effect corresponding to the plurality of color layers further causes the at least one processor to:
determine a matrix for rotating the animation texture; and
rotate the animation texture based on the matrix.

20. A non-transitory computer-readable storage medium storing a computer program thereon, wherein the computer program, when executed by a processor, causes the processor to:
determine, from a user interface, a plurality of colors available for the dynamic background;
generate a plurality of color layers based on the plurality of colors, colors in the plurality of color layers being different;
determine a dynamic graphic and an animation effect corresponding to the plurality of color layers; and
generate the dynamic background based on the plurality of color layers, the dynamic graphic and the animation effect.
